(19) United States
(12) Patent Application Publication
(10) Pub. No.: US 2020/0231099 A1
(43) Pub. Date: Jul. 23, 2020

(54) IMAGE PROCESSING APPARATUS

(71) Applicant: DENSO CORPORATION, Kariya-city (JP)

(72) Inventor: Kenji KOHARA, Kariya-city (JP)

(21) Appl. No.: 16/844,294

(22) Filed: Apr. 9, 2020

Related U.S. Application Data
(63) Continuation of application No. PCT/JP2018/037941, filed on Oct. 11, 2018.

(30) Foreign Application Priority Data
Oct. 13, 2017 (JP) 2017-199383

(51) Int. Cl. B60R 11/04; G06T 1/00; G06T 7/80

(52) U.S. Cl. CPC B60R 11/04; G06T 1/0007; G06T 2207/10012; G06T 2207/30252; G06T 7/85

(57) ABSTRACT

An image processing apparatus is mounted on a vehicle. The image processing apparatus includes an image acquiring unit, a boundary setting unit, a display image generating unit, and a direction change acquiring unit. The display image generating unit generates a display image by synthesizing a plurality of images at the boundaries. The direction change acquiring unit acquires a direction of change from a straight traveling direction of the vehicle, and a change amount. The display image generating unit sets a display range of the display image closer to the direction of change from the straight traveling direction as the change amount from a traveling direction increases. The boundary setting unit sets a position of at least a part of a boundary existing closer to the direction of change among boundaries within the display image closer to the direction of change as the change amount increases.

### CROSS-REFERENCE TO RELATED APPLICATION

This application is the U.S. bypass application of International Application No. PCT/JP2018/037941, filed Oct. 11, 2018 which designated the U.S. and claims priority to Japanese Patent Application No. 2017-199383, filed Oct. 13, 2017, the contents of both of which are incorporated herein by reference.

### TECHNICAL FIELD

The present disclosure relates to an image processing apparatus.

### BACKGROUND

Conventionally, an image processing apparatus as described below is known. A plurality of images representing the surroundings of a vehicle are acquired using a plurality of cameras. A display image viewed from a viewpoint of a driver of the vehicle is created by synthesizing the plurality of images. This image processing apparatus is disclosed in JP 6014433 B, for example.

### SUMMARY

One aspect of the present disclosure is an image processing apparatus configured to be mounted on a vehicle. An image processing apparatus according to one aspect of the present disclosure includes an image acquiring unit configured to acquire a plurality of images in which parts of ranges which can be displayed overlap with each other, using a plurality of cameras which capture the surroundings of the vehicle.

An image processing apparatus according to one aspect of the present disclosure includes a boundary setting unit configured to set boundaries of images in which parts of ranges which can be displayed overlap with each other, included in the plurality of images, within ranges in which the ranges which can be displayed overlap.

An image processing apparatus according to one aspect of the present disclosure includes a display image generating unit configured to generate a display image viewed from a viewpoint within a vehicle interior of the vehicle by synthesizing at least parts of the plurality of images at the boundaries.

An image processing apparatus according to one aspect of the present disclosure includes an output unit configured to output the display image.

An image processing apparatus according to one aspect of the present disclosure includes a direction change acquiring unit configured to acquire a direction of change from a straight traveling direction of the vehicle, and a change amount from the straight traveling direction.

The display image generating unit is configured to set a display range of the display image closer to the direction of change as the change amount increases, and the boundary setting unit is configured to set a position of at least a part of at least the boundary existing on the direction of change among the boundaries within the display image closer to the direction of change as the change amount increases.

### BRIEF DESCRIPTION OF THE DRAWINGS

The above objects and other objects, features and advantages of the present disclosure will be made clearer by the following detailed description, given referring to the appended drawings.

In the accompanying drawings:

FIG. 1 is a block diagram illustrating configurations of an in-vehicle system and an image processing apparatus;

FIG. 2 is a block diagram illustrating a functional configuration of the image processing apparatus;

FIG. 3 is a bird's eye view illustrating a plurality of images and boundaries;

FIG. 4 is a flowchart illustrating processing to be performed by the image processing apparatus;

FIG. 5 is a bird's-eye view illustrating a configuration of a viewpoint, a line-of-sight direction, a display range, or the like;

FIG. 6 is an explanatory diagram illustrating an example of a display image;

FIG. 7 is a bird's-eye view illustrating a configuration of a viewpoint, a line-of-sight direction, a display range, or the like;

FIG. 8 is an explanatory diagram illustrating an example of the display image; and

FIG. 9 is an explanatory diagram illustrating a method for setting a boundary.

### DETAILED DESCRIPTION OF THE PREFERRED EMBODIMENTS

As a result of detailed studies by the inventor, the following problems have been found. Within a display image, there are boundaries between a plurality of images which are used for synthesis. In a case where a traveling direction of a vehicle changes, it is conceivable to move a display range of the display image to a direction in which the traveling direction is changed (hereinafter, referred to as a direction of change from a straight traveling direction). For example, in a case where left and right boundaries between an image captured by a front camera and images captured by side cameras are respectively set at positions at 45 degrees with respect to the straight traveling direction when the vehicle travels straight forward, if the positions of the boundaries are always fixed, in a case where the display range of the display image is moved to the direction of change from the straight traveling direction, a position of at least a part of the boundaries approaches a center of a display screen.

In the image near the boundary, a phenomenon such as distortion or one object being doubly displayed may occur due to a difference of imaging positions of two images to be synthesized or through conversion. Therefore, the image near the boundary may cause user discomfort. The imaging positions are positions where the cameras are provided. If the boundary is located near the center of the display image, it becomes difficult for a passenger of the vehicle to recognize a surrounding object from the display image. In one aspect of the present disclosure, it is preferable to provide an image processing apparatus which is capable of preventing the boundary from approaching the center of the display screen.

One aspect of the present disclosure is an image processing apparatus configured to be mounted on a vehicle. An image processing apparatus according to one aspect of the present disclosure includes an image acquiring unit configured to acquire a plurality of images in which parts of ranges which can be displayed overlap with each other, using a plurality of cameras which capture the surroundings of the vehicle.

An image processing apparatus according to one aspect of the present disclosure includes a boundary setting unit configured to set boundaries of images in which parts of ranges which can be displayed overlap with each other, included in the plurality of images, within ranges in which the ranges which can be displayed overlap.

An image processing apparatus according to one aspect of the present disclosure includes a display image generating unit configured to generate a display image viewed from a viewpoint within a vehicle interior of the vehicle by synthesizing at least parts of the plurality of images at the boundaries.

An image processing apparatus according to one aspect of the present disclosure includes an output unit configured to output the display image.

An image processing apparatus according to one aspect of the present disclosure includes a direction change acquiring unit configured to acquire a direction of change from a straight traveling direction of the vehicle, and a change amount from the straight traveling direction.

The display image generating unit is configured to set a display range of the display image closer to the direction of change as the change amount increases, and the boundary setting unit is configured to set a position of at least a part of at least the boundary existing on the direction of change among the boundaries within the display image closer to the direction of change as the change amount increases.

The image processing apparatus according to one aspect of the present disclosure sets the display range of the display image closer to the direction of change from the straight traveling direction as the change amount from the straight traveling direction increases. If the positions of the boundaries with respect to a plurality of images were always fixed, the position of part of the boundaries would approach the center of the display image as the change amount from the straight traveling direction increases.

If the image is near the boundary, it may be unclear and may cause the user to feel uncomfortable. If the boundary is located near the center of the display image, it becomes difficult for a passenger of the vehicle to recognize a surrounding target from the display image.

An image processing apparatus according to one aspect of the present disclosure sets a position of at least a part of the boundary existing closer to the direction of change from the straight traveling direction among the boundaries within the display image, closer to the direction of change from the straight traveling direction as the change amount from the straight traveling direction increases. Therefore, the image processing apparatus according to one aspect of the present disclosure can prevent the position of the boundary from approaching the center of the display image even in a case where the traveling direction of the vehicle changes. As a result, it becomes easy for a passenger of the vehicle to recognize a target in the surrounding from the display image.

Exemplary embodiments of the present disclosure will be described with reference to the drawings.

### First Embodiment

1. Configurations of in-Vehicle System 1 and Image Processing Apparatus 3

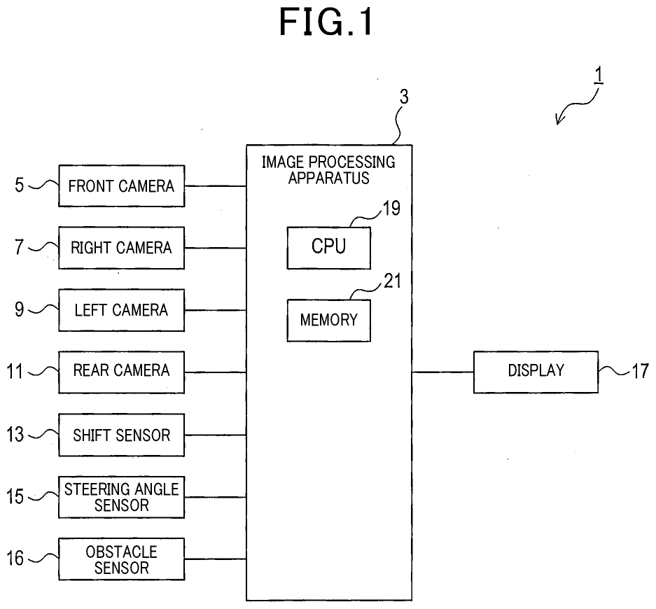

The configurations of an in-vehicle system 1 and an image processing apparatus 3 will be described with reference to FIGS. 1 to 3. The in-vehicle system 1 illustrated in FIG. 1 is a system mounted on a vehicle. Hereinafter, the vehicle on which the in-vehicle system 1 is mounted will be referred to as an own vehicle. The in-vehicle system 1 includes an image processing apparatus 3, a front camera 5, a right camera 7, a left camera 9, and a rear camera 11. The image processing apparatus 3 and the cameras 5, 7, 9, and 11 are connected via an image transmission line such as LVDS. Image data captured by the respective cameras 5, 7, 9 and 11 is transmitted to the image processing apparatus 3 as needed. The in-vehicle system 1 is connected to a shift sensor 13, a steering angle sensor 15, and an obstacle sensor 16 via an in-vehicle communication bus such as in-vehicle CAN (registered trademark) and LIN. The in-vehicle system 1 and a display 17 are connected via an image transmission line.

The image processing apparatus 3 includes a microcomputer having a CPU 19 and a semiconductor memory (hereinafter, referred to as a memory 21) such as, for example, a RAM and a ROM. Each function of the image processing apparatus 3 is realized by the CPU 19 executing a program stored in a non-transitory computer-readable storage medium. In this example, the memory 21 corresponds to a non-transitory computer-readable storage medium which stores a program. Further, a method corresponding to the program is performed by this program being performed. Note that the image processing apparatus 3 may include one microcomputer or may include a plurality of microcomputers.

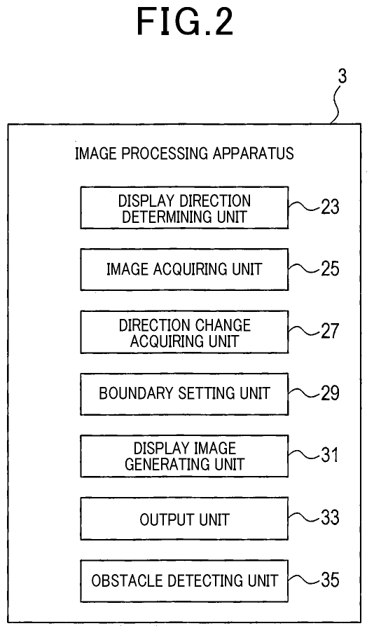

As illustrated in FIG. 2, the image processing apparatus 3 includes a display direction determining unit 23, an image acquiring unit 25, a direction change acquiring unit 27, a boundary setting unit 29, a display image generating unit 31, an output unit 33, and an obstacle detecting unit 35.

A method for realizing functions of the respective units included in the image processing apparatus 3 is not limited to software, and part or all of the functions may be realized using one or a plurality of pieces of hardware. For example, in a case where the above-described functions are realized by an electronic circuit which is hardware, the electronic circuit may be realized by a digital circuit, an analog circuit, or a combination thereof.

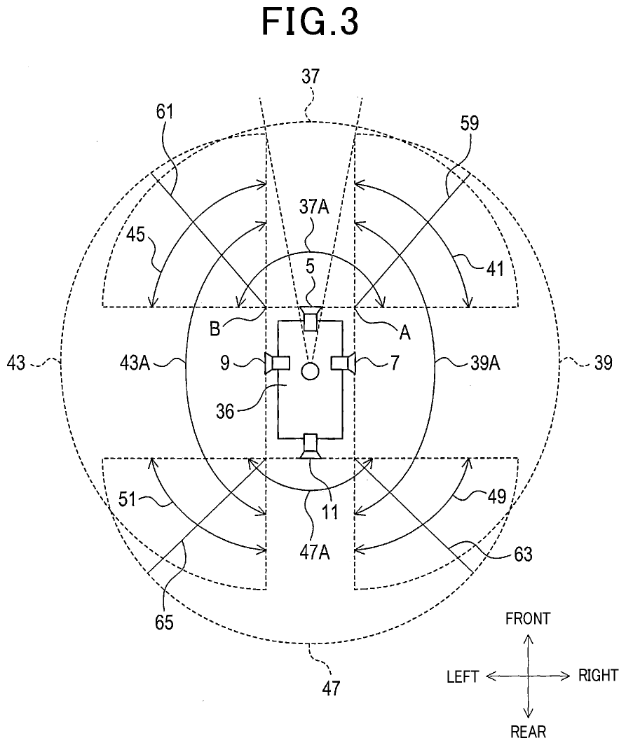

As illustrated in FIG. 3, the front camera 5 captures a front portion among the surroundings of the own vehicle 36 and generates an image (hereinafter, referred to as a front image 37). The front camera 5 includes, for example, a fisheye lens, or the like. A displayable range 37A of the front image 37 is, for example, approximately 180 degrees.

The right camera 7 captures a right portion among the surroundings of the own vehicle 36 and generates an image (hereinafter, referred to as a right image 39). The right camera 7 includes, for example, a fisheye lens, or the like. A displayable range 39A of the right image 39 is, for example, approximately 180 degrees. Part of the displayable range 37A of the front image 37 overlaps with part of the displayable range 39A of the right image 39. A range that is overlapping is defined as an overlapping range 41. The overlapping range 41 is, for example, 90 degrees.

The left camera 9 captures a left portion among the surroundings of the own vehicle 36 and generates an image (hereinafter, referred to as a left image 43). The left camera 9 includes, for example, a fisheye lens, or the like. A displayable range 43A of the left image 43 is, for example, approximately 180 degrees. Part of the displayable range 43A of the left image 43 overlaps with part of the displayable range 37A of the front image 37. An overlapping range is defined as an overlapping range 45. The overlapping range 45 is, for example, 90 degrees.

The rear camera 11 captures a rear portion among the surroundings of the own vehicle 36 and generates an image (hereinafter, referred to as a rear image 47). The rear camera 11 includes, for example, a fisheye lens, or the like. A displayable range 47A of the rear image 47 is, for example, approximately 180 degrees. Part of the displayable range 47A of the rear image 47 overlaps with part of the displayable range 39A of the right image 39. A range that is overlapping is defined as an overlapping range 49. The overlapping range 49 is, for example, 90 degrees.

Further, part of the displayable range 47A of the rear image 47 overlaps with part of the displayable range 43A of the left image 43. A range that is overlapping is defined as an overlapping range 51. The overlapping range 51 is, for example, 90 degrees.

The shift sensor 13 detects a state of a gear shift of the own vehicle and creates shift information. The shift sensor 13 transmits the shift information to the in-vehicle CAN. The shift information is information representing the state of the gear shift of the own vehicle. Examples of the state of the gear shift can include, for example, forward movement and backward movement.

The steering angle sensor 15 detects a direction and an amount of the steering angle of the own vehicle, and creates steering angle information. The steering angle sensor 15 transmits the steering angle information to the in-vehicle CAN. The steering angle information is information representing the direction of the steering angle of the own vehicle and the amount of the steering angle. The direction of the steering angle corresponds to the direction of change from the straight traveling direction of the own vehicle. Examples of the direction of the steering angle can include, for example, turning right after traveling straight, turning left after traveling straight, further turning right after turning right, and steering left after turning right. The amount of the steering angle corresponds to the change amount from the straight traveling direction of the own vehicle. The amount of the steering angle represents a degree of turning with respect to the straight traveling direction of the own vehicle. The amount of the steering angle is expressed as an angle.

The obstacle sensor 16 detects an obstacle existing around the own vehicle and creates obstacle information. The obstacle information is information regarding an obstacle. The obstacle information represents, for example, a position of the obstacle with respect to the own vehicle, a relative distance from the own vehicle to the obstacle, relative speed of the obstacle with respect to the own vehicle, or the like. The obstacle sensor 16 transmits the obstacle information to the in-vehicle CAN. Examples of the obstacle sensor 16 can include, for example, a millimeter wave radar and a lidar.

The display 17 is provided in the vehicle interior of the own vehicle. The display 17 is provided in, for example, an instrument panel portion. The instrument panel portion is aligned with a dashboard portion, a console portion, a meter, or the like. The display 17 can display an image. The image displayed on the display 17 includes a virtual screen after mapping which will be described later or a display image extracted from a synthesized image, a navigation screen, various kinds of indicators, an operation screen for air conditioning, audio, or the like.

### 2. Processing to be Performed by Image Processing Apparatus 3

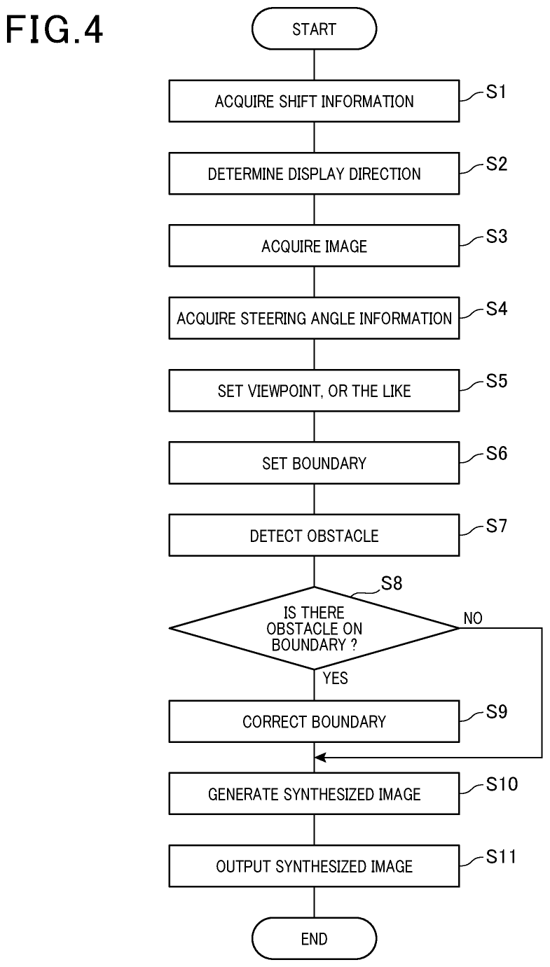

Processing to be repeatedly performed by the image processing apparatus 3 at predetermined time intervals will be described based on FIGS. 4 to 6. In step 1 in FIG. 4, the display direction determining unit 23 acquires the shift information from the shift sensor 13.

In step 2, the display direction determining unit 23 determines the display direction. The display direction is a direction of display shown by a display image which will be described later. The display direction includes a forward direction and a backward direction. In a case where the state of the gear shift represented by the shift information acquired in step 1 is forward movement, the display direction determining unit 23 sets the display direction to the forward direction. In a case where the state of the gear shift represented by the shift information acquired in step 1 is backward movement, the display direction determining unit 23 sets the display direction to the backward direction.

In step 3, the image acquiring unit 25 acquires the front image 37, the right image 39, the left image 43, and the rear image 47 from the front camera 5, the right camera 7, the left camera 9, and the rear camera 11.

In step 4, the direction change acquiring unit 27 acquires the steering angle information from the steering angle sensor 15.

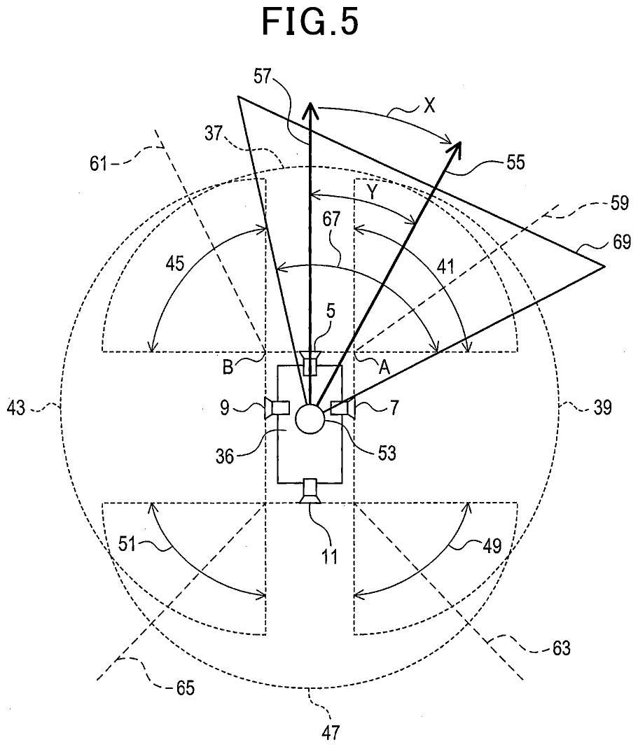

In step 5, the display image generating unit 31 sets a viewpoint 53 in the vehicle interior of the own vehicle 36 as illustrated in FIG. 5. The position of the viewpoint 53 with respect to the own vehicle 36 is always fixed. Further, the display image generating unit 31 sets a line-of-sight direction 55 based on the steering angle information, using the viewpoint 53 as a starting point.

In a case where the display direction determined in step 2 is the forward direction, the straight traveling direction 57 of the own vehicle is the forward direction of the own vehicle 36. The line-of-sight direction 55 is a direction rotated from the straight traveling direction 57 in a steering angle direction X around the viewpoint 53. In a case where the straight traveling direction 57 is the forward direction, the steering angle direction X corresponds to the direction of change from the straight traveling direction 57.

On the other hand, in a case where the display direction determined in step 2 is the backward direction, the straight traveling direction 57 is the backward direction of the own vehicle 36. The line-of-sight direction 55 is a direction rotated from the straight traveling direction 57 in a direction opposite to the steering angle direction X around the viewpoint 53. In a case where the straight traveling direction 57 is the backward direction, a direction opposite to the steering angle direction X corresponds to the direction of change from the straight traveling direction 57.

Regardless of whether the display direction determined in step 2 is the forward direction or the backward direction, an angle Y formed by the line-of-sight direction 55 and the straight traveling direction 57 is larger as the amount of the steering angle increases. The steering angle direction X and the amount of the steering angle are included in the steering angle information acquired in step 4. A map which defines relationship between the angle Y and the amount of the steering angle is stored in the memory 21 in advance. The display image generating unit 31 sets the line-of-sight direction 55 using this map and the steering angle information. Note that the relationship between the angle Y and the steering angle may be calculated from a predetermined formula instead of using the map.

In step 6, the boundary setting unit 29 sets a boundary. This processing will be described based on the example illustrated in FIG. 5. In the example illustrated in FIG. 5, the display direction determined in step 2 is the forward direction, and the straight traveling direction 57 is the forward direction. Further, in the example illustrated in FIG. 5, the steering angle direction X included in the steering angle information acquired in step 4 is the rightward direction. The direction of change from the straight traveling direction 57 is the steering angle direction X.

The boundary setting unit 29 sets a boundary 59 within the overlapping range 41. The boundary setting unit 29 sets a boundary 61 within the overlapping range 45. The boundary 59 is a line where a virtual screen, which will be described later, intersects with a vertical plane passing through an intersection A inside the overlapping area 41. The boundary 61 is a line where a virtual screen, which will be described later, intersects with a vertical plane passing through an intersection B inside the overlapping area 45.

Here, the intersections A and B are intersections of frame lines which define the ranges which can be displayed of images captured by the respective cameras. The ranges which can be displayed of the images captured by the respective cameras are image areas to be used for display among the images captured by the respective cameras. The boundaries 59 and 61 are boundaries which may be included in a display image which will described later in a case where the display direction determined in step 2 is the forward direction. In the example illustrated in FIG. 5, the boundary 59 is a boundary which exists closer to the direction of change from the straight traveling direction 57 among the boundaries in the display image.

The boundary setting unit 29 sets a position of at least a part of the boundary 59 closer to the steering angle direction X as the amount of the steering angle increases. The steering angle direction X and the amount of the steering angle are included in the steering angle information acquired in step 4. A map which defines relationship between the position of a part of the boundary 59 and the amount of the steering angle is stored in the memory 21 in advance. The boundary setting unit 29 sets the position of the boundary 59 using this map and the steering angle information. The boundary setting unit 29 sets a position of the boundary 61 at, for example, a standard position. The standard position is, for example, a position at 45 degrees with respect to the straight traveling direction 57. The standard position is stored in the memory 21 in advance.

Unlike with the example illustrated in FIG. 5, in a case where the display direction determined in step 2 is the forward direction and the steering angle direction X included in the steering angle information acquired in step 4 is the leftward direction, the boundary 61 is a boundary existing closer to the direction of change from the straight traveling direction 57 among the boundaries within the display image. In this case, the boundary setting unit 29 sets a position of at least a part of the boundary 61 closer to the steering angle direction X as the amount of the steering angle increases. Further, the boundary setting unit 29 sets the position of the boundary 59 at the standard position.

Unlike with the example illustrated in FIG. 5, in a case where the display direction determined in step 2 is the backward direction and the steering angle direction X included in the steering angle information acquired in step 4 is the rightward direction, the boundary setting unit 29 sets a boundary 63 in the overlapping range 49 and sets a boundary 65 in the overlapping range 51. The boundaries 63 and 65 are lines where a virtual screen, which will be described later, intersects with a vertical plane passing through intersections inside the overlapping ranges 49 and 51. The boundaries 63 and 65 are boundaries which may be included in a display image which will be described later in a case where the display direction determined in step 2 is the backward direction.

In a case where the display direction determined in step 2 is the backward direction, the direction of change from the straight traveling direction 57 is a direction opposite to the steering angle direction X. In a case where the steering angle direction X included in the steering angle information acquired in step 4 is the rightward direction, the boundary 63 is a boundary existing closer to the direction of change from the straight traveling direction 57 among the boundaries within the display image. The boundary setting unit 29 sets a position of at least a part of the boundary 63 closer to the direction of change from the straight traveling direction 57 as the amount of the steering angle increases. Further, the boundary setting unit 29 sets a position of the boundary 65 at the standard position.

Unlike with the example illustrated in FIG. 5, in a case where the display direction determined in step 2 is the backward direction and the steering angle direction X included in the steering angle information acquired in step 4 is the leftward direction, the boundary setting unit 29 sets the boundary 63 in the overlapping range 49 and sets the boundary 65 in the overlapping range 51.

In a case where the display direction determined in step 2 is the backward direction, the direction of change from the straight traveling direction 57 is a direction opposite to the steering angle direction X. In a case where the steering angle direction X included in the steering angle information acquired in step 4 is the leftward direction, the boundary 65 is a boundary existing closer to the direction of change from the straight traveling direction 57 among the boundaries in the display image. The boundary setting unit 29 sets a position of at least a part of the boundary 65 closer to the direction of change from the straight traveling direction 57 as the amount of the steering angle increases. Further, the boundary setting unit 29 sets a position of the boundary 63 at the standard position.

In step 7, the obstacle detecting unit 35 performs processing of detecting an obstacle existing around the own vehicle using the obstacle information transmitted from the obstacle sensor 16.

In step 8, the boundary setting unit 29 judges whether the obstacle detected in step 7 is located near the boundary set in step 6 when viewed from the viewpoint 53. In a case where the obstacle is located on the boundary, the processing proceeds to step 9, while, in a case where the obstacle is not on the boundary, the processing proceeds to step 10.

In step 9, the boundary setting unit 29 corrects a position of the boundary set in step 6 so as to avoid the obstacle detected in step 7. Here, when the position of the boundary is corrected so as to avoid the obstacle, the position is corrected so as to avoid the obstacle in the same direction as the steering angle direction X while the steering angle direction X is taken into account.

In step 10, the display image generating unit 31 generates a display image as follows. The display image generating unit 31 assumes there is a virtual screen around the own vehicle in three-dimensional space. The virtual screen is an image projection plane. Next, the display image generating unit 31 performs mapping by projecting the front image 37, the right image 39, the left image 43, and the rear image 47 acquired in step 3 onto the above-described virtual screen.

Next, as illustrated in FIG. 5, the display image generating unit 31 sets, as a display image 69, an image which is visible within the display range 67 from the viewpoint 53 among the virtual screen after mapping. Further, as illustrated in FIG. 5, the display image generating unit 31 may use, as the display image 69, an image which is visible within the display range 67 from the viewpoint 53 among an image obtained by synthesizing the images acquired from the respective cameras at the same viewpoint. The display range 67 is a range having a certain spread around the line-of-sight direction 55. The display range 67 is set closer to the direction of change from the straight traveling direction 57 as the amount of the steering angle increases.

That is, in a case where the straight traveling direction 57 is the forward direction, the display range 67 is set closer to the steering angle direction X as the amount of the steering angle increases. Further, in a case where the straight traveling direction 57 is the backward direction, the display range 67 is set closer to a side opposite to the steering angle direction X as the amount of the steering angle increases.

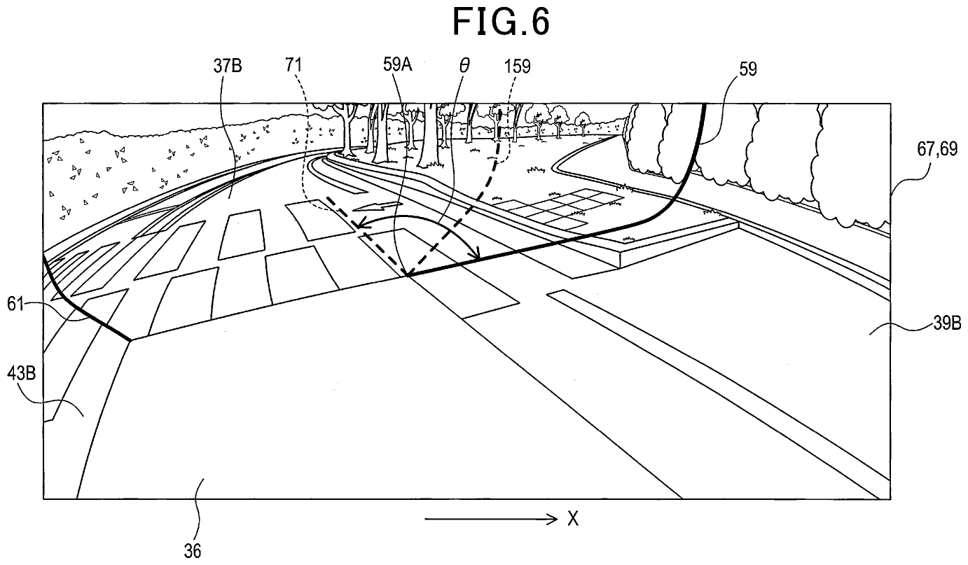

The display image 69 is an image obtained by synthesizing at least parts of the front image 37, the right image 39, the left image 43, and the rear image 47 at the boundaries. An example of the display image 69 is illustrated in FIG. 6.

The display image 69 illustrated in FIG. 6 is a display image 69 in a case where the display direction determined in step 2 is the forward direction, and the steering angle direction X included in the steering angle information acquired in step 4 is the rightward direction. A position of the display range 67 in this display image 69 is set at a position in the rightward direction compared to a case where the steering angle is 0 degree. The rightward direction is the direction of change from the straight traveling direction 57 in this example.

In the display image 69, a front extracted image 37B and a right extracted image 39B are joined at the boundary 59. The front extracted image 37B is a portion between the boundary 59 and the boundary 61 in the front image 37. The right extracted image 39B is a portion on the right side of the boundary 59 in the right image 39, when viewed from the viewpoint 53.

Further, in the display image 69, the front extracted image 37B and a left extracted image 43B are joined at the boundary 61. The left extracted image 43B is a portion on the left side of the boundary 61 in the left image 43, when viewed from the viewpoint 53.

In step 6, the position of at least a part of the boundary 59 is set closer to the direction of change from the straight traveling direction 57 as the amount of the steering angle increases. As a method for setting the position of at least a part of the boundary 59 closer to the direction of change from the straight traveling direction 57 as the amount of the steering angle increases, for example, as illustrated in FIG. 6, there is a method in which the boundary 59 is inclined more toward the direction of change from the straight traveling direction 57 as the amount of steering angle increases. In this method, for example, a position of a lower end 59A of the boundary 59 can be set at a fixed position with respect to the own vehicle. An axis 71 which is fixed at a frame representing the own vehicle 36 and which is located in a direction opposite to the steering angle direction X when viewed from the boundary 59 is assumed. Note that the axis 71 is a part of the frame line of the right image 39 and is substantially parallel to the straight traveling direction 57. An angle θ formed by the axis 71 and the boundary 59 becomes larger as the boundary 59 is inclined more toward the direction of change from the straight traveling direction 57.

The display image generating unit 31 generates a display image also in a case where the display direction determined in step 2 is the backward direction, and in a case where the steering angle direction X included in the steering angle information acquired in step 4 is the leftward direction, in a similar manner to the case of the display image 69 illustrated in FIG. 6.

In step 11, the output unit 33 outputs the display image generated in step 10 to the display 17. The display 17 displays the display image.

### 3. Effects to be Provided by Image Processing Apparatus 3

(1A) The image processing apparatus 3 sets the display range 67 closer to the direction of change from the straight traveling direction 57 as the amount of the steering angle increases. Therefore, if the position of the boundary with respect to the front image 37, the right image 39, the left image 43, and the rear image 47 is always fixed, the position of a part of the boundary approaches the center of the display image as the amount of steering angle increases.

For example, in the display image 69, if the position of the boundary with respect to the front image and the right image is always fixed, in a case where the display range 67 is set closer to the steering angle direction X, the position of the boundary approaches the center of the display image 69 in a similar manner to a boundary 159.

In the image near the boundary, a phenomenon such as distortion or one object being displayed doubly may occur due to a difference of imaging positions of two images to be synthesized or through conversion. The imaging positions are positions where the cameras are provided. If the boundary is located in the vicinity of the center of the display image, it becomes difficult for the passenger of the own vehicle to recognize a surrounding target from the display image.

The image processing apparatus 3 sets at least a part of a position on the boundary existing closer to the direction of change from the straight traveling direction 57 among the boundaries within the display image closer to the direction of change from the straight traveling direction 57 as the amount of the steering angle increases. Therefore, the image processing apparatus 3 can prevent the position of the boundary from approaching the center of the display image even in a case where the line-of-sight direction 55 changes. As a result, it becomes easy for the passenger of the own vehicle to recognize a surrounding target from the display image.

(1B) The image processing apparatus 3 tilts the boundary existing closer to the direction of change from the straight traveling direction 57 among the boundaries within the display image closer to the direction of change from the straight traveling direction 57 as the amount of the steering angle increases. Therefore, the image processing apparatus 3 can make settings so that the boundary does not approach the center of the display screen. As a result, the image processing apparatus 3 can prevent the user from feeling uncomfortable.

(1C) The image processing apparatus 3 specifies a position of the obstacle based on the information transmitted from the obstacle sensor 16. Then, the image processing apparatus 3 sets a boundary while avoiding the detected obstacle. Therefore, it becomes easy for the passenger of the own vehicle to recognize an obstacle in the display image.

(1D) The image processing apparatus 3 generates a display image 69 viewed from the viewpoint 53 in the line-of-sight direction 55. Further, the image processing apparatus 3 sets the line-of-sight direction 55 closer to the direction of change from the straight traveling direction 57 as the amount of the steering angle increases. It is therefore possible to obtain the display image 69 with a fixed position of the viewpoint 53.

### Second Embodiment

1. Differences from First Embodiment

Since a basic configuration of a second embodiment is similar to that of the first embodiment, differences will be described below. Note that the same reference numerals as those in the first embodiment indicate the same components, and the preceding description will be referred to.

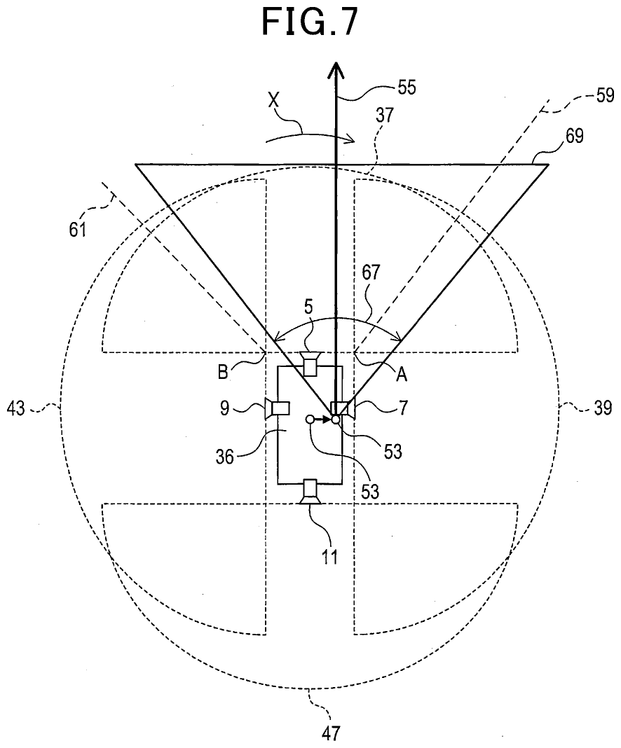

In the first embodiment described above, the position of the viewpoint 53 is fixed, and the line-of-sight direction 55 is changed in accordance with the steering angle direction X. In contrast, in the second embodiment, the line-of-sight direction 55 is fixed as illustrated in FIG. 7. Further, in the second embodiment, the position of the viewpoint 53 is changed in accordance with the direction of change from the straight traveling direction 57. The position of the viewpoint 53 changes in a left-right direction of the own vehicle. The position of the viewpoint 53 is set closer to the direction of change from the straight traveling direction 57 as the amount of the steering angle increases. The direction of change from the straight traveling direction 57 is the steering angle direction X in a case where the straight traveling direction 57 is the forward direction. Further, the direction of change from the straight traveling direction 57 is a direction opposite to the steering angle direction X in a case where the straight traveling direction 57 is the backward direction.

In step 10, the display image generating unit 31 sets an image which is visible within the display range 67 from the viewpoint 53 set as described above as a display image 69. The display range 67 is a range having a certain spread around the fixed line-of-sight direction 55. The display range 67 is set closer to the direction of change from the straight traveling direction 57 as the amount of steering angle increases.

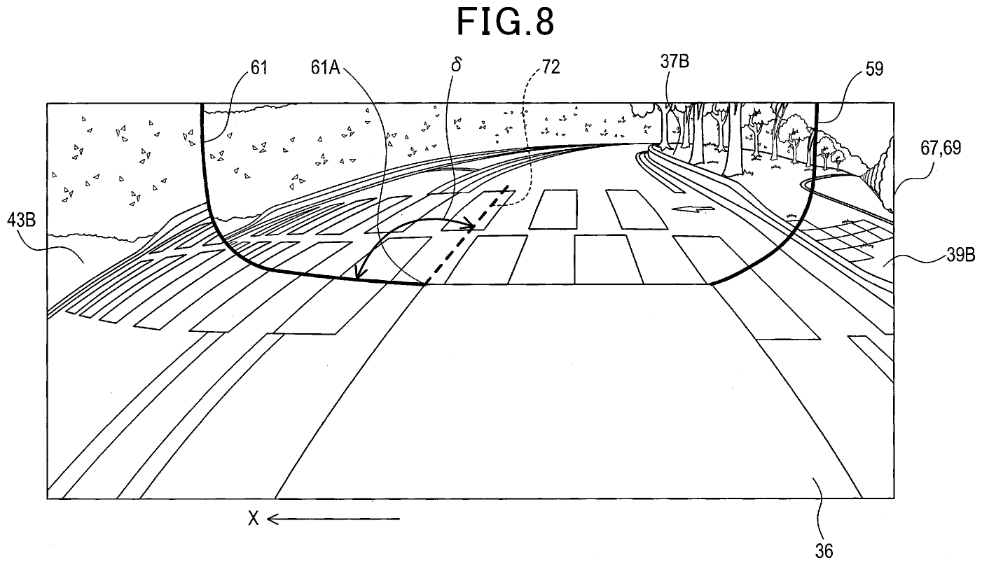

An example of the display image 69 is illustrated in FIG. 8. The display image 69 is a display image 69 in a case where the display direction is the forward direction and the steering angle direction X is the leftward direction. The position of the display range 67 in this display image 69 is set in the leftward direction compared to a case where the steering angle is 0 degree. The leftward direction is the direction of change from the straight traveling direction 57 in this example.

In the display image 69, the front extracted image 37B and the right extracted image 39B are joined at the boundary 59. Further, in the display image 69, the front extracted image 37B and the left extracted image 43B are joined at the boundary 61.

A position of at least a part of the boundary 61 is set closer to the direction of change from the straight traveling direction 57 as the amount of the steering angle increases. As a method for setting the position of at least a part of the boundary 61 closer to the direction of change from the straight traveling direction 57 as the amount of the steering angle increases, for example, as illustrated in FIG. 8, there is a method in which the boundary 61 is inclined more toward the direction of change from the straight traveling direction 57 as the amount of the steering angle increases. In this method, for example, the position of a lower end 61A of the boundary 61 can be set at a position fixed with respect to the own vehicle 36. An axis 72 is assumed. The axis 72 is an axis fixed with respect to a frame representing the own vehicle 36. The axis 72 is an axis in a direction opposite to the steering angle direction X when viewed from the boundary 61. Note that the axis 72 is a part of a frame line of the left image 43 and is substantially parallel to the straight traveling direction 57. An angle δ formed by the axis 72 and the boundary 61 becomes larger as the boundary 61 is inclined more toward the direction of change from the straight traveling direction 57.

### 2. Effects to be Provided by Image Processing Apparatus 3

According to the second embodiment described in detail above, the effects (1A) to (1C) of the first embodiment described above are provided, and the following effects are further provided.

(2A) The image processing apparatus 3 generates the display image 69 viewed from the viewpoint 53 in the line-of-sight direction 55. Further, the image processing apparatus 3 sets the viewpoint 53 closer to the steering angle direction X as the amount of the steering angle increases. The image processing apparatus 3 can obtain the display image 69 with a fixed position of the line-of-sight direction 55.

### Other Embodiments

While the embodiments of the present disclosure have been described above, the present disclosure is not limited to the above-described embodiments, and can be implemented with various modifications.

(1) The direction change acquiring unit 27 may calculate the direction of change from the straight traveling direction 57 and the change amount from the straight traveling direction 57 from parameters other than the steering angle. For example, the direction of change from the straight traveling direction 57 and the change amount from the straight traveling direction 57 may be calculated from a yaw rate of the own vehicle, display of a directional signal, display of a hazard light, or the like.

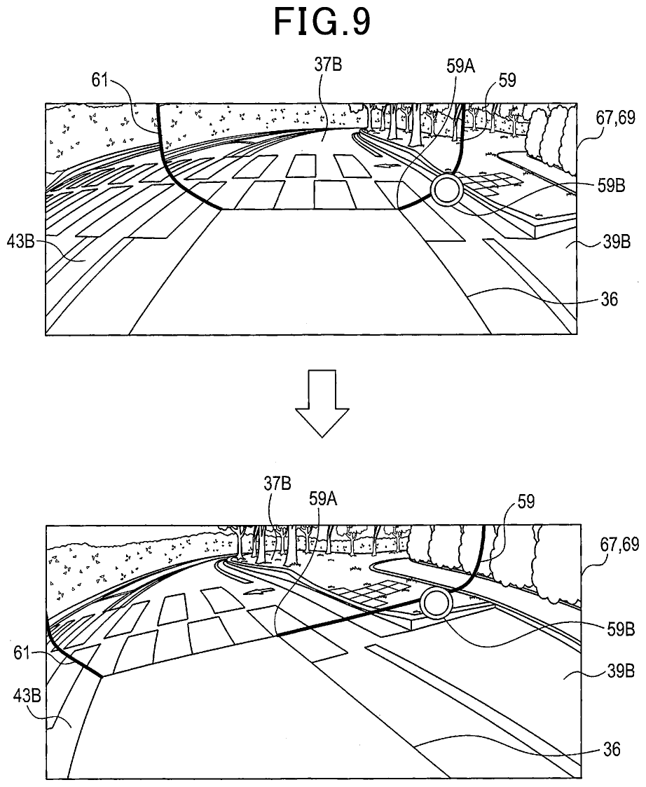

(2) A method for setting the boundary in step 6 may be, for example, the following method. FIG. 9 illustrates the display image 69 before and after the straight traveling direction changes to the rightward direction. The boundary 59 is a boundary existing closer to the direction of change from the straight traveling direction 57 among the boundaries within the display image 69. The position of a fixed point 59B, which is a part of the boundary 59, with respect to the display range 67 is fixed before and after the straight traveling direction 57 changes to the rightward direction. The fixed point 59B is, for example, a portion other than the lower end 59A.

(3) The obstacle detecting unit 35 may detect an obstacle using results of image processing on images captured by the front camera 5, the right camera 7, the left camera 9, and the rear camera 11 in place of the information from the obstacle sensor 16, or may detect an obstacle by integrating the information from the obstacle sensor 16 and results of image recognition. The image processing on the captured images is image recognition of the captured images.

It is also possible to change both the position of the viewpoint 53 and the line-of-sight direction 55 in accordance with the amount of the steering angle to generate a display image by combining the first and second embodiments.

(4) A plurality of functions of one component in the above-described embodiments may be realized by a plurality of components, or a single function of one component may be realized by a plurality of components. Further, a plurality of functions of a plurality of components may be realized by one component, or one function realized by a plurality of components may be realized by one component. Further, part of the components of the above-described embodiments may be omitted. Further, at least a part of the components of the above-described embodiments may be added to or replaced with the components of other embodiments. Note that embodiments of the present disclosure incorporate any aspect included in technical idea specified from wording recited in the claims.

(5) The present disclosure can be realized in various modes such as, in addition to the above-described image processing apparatus, a system having the image processing apparatus as a component, a program for causing a computer to function as the image processing apparatus, a non-transitory computer-readable storage medium such as a semiconductor memory in which this program is recorded, an image processing method, an image display method, and a drive assisting method.

What is claimed is:

1. An image processing apparatus configured to be mounted on a vehicle, the image processing apparatus comprising:
an image acquiring unit configured to acquire a plurality of images in which parts of ranges which can be displayed overlap with each other, using a plurality of cameras which capture surroundings of the vehicle;
a boundary setting unit configured to set boundaries of the images in which parts of the ranges which can be displayed overlap with each other, included in the plurality of images, within ranges in which the ranges which can be displayed overlap;
a display image generating unit configured to generate a display image viewed from a viewpoint within a vehicle interior of the vehicle by synthesizing at least parts of images of the plurality of images at the boundaries;
an output unit configured to output the display image; and
a direction change acquiring unit configured to acquire a direction of change from a straight traveling direction of the vehicle, and a change amount from the straight traveling direction, wherein
the display image generating unit is configured to set a display range of the display image closer to the direction of change as the change amount increases, and
the boundary setting unit is configured to set a position of at least a part of at least the boundary existing closer to the direction of change among the boundaries within the display image closer to the direction of change as the change amount increases.

2. The image processing apparatus according to claim 1, wherein
the boundary setting unit is configured to tilt the boundary existing closer to the direction of change among the boundaries within the display image toward the direction of change as the change amount increases.

3. The image processing apparatus according to claim 1, further comprising:
an obstacle detecting unit configured to detect an obstacle, wherein
the boundary setting unit is configured to set the boundary so as to avoid the obstacle detected at the obstacle detecting unit.

4. The image processing apparatus according to a claim 1, wherein
the display image generating unit is configured to generate a display image viewed from the viewpoint in a line-of-sight direction, and
the display image generating unit is configured to set the line-of-sight direction closer to the direction of change as the change amount increases.

5. The image processing apparatus according to claim 1, wherein
the display image generating unit is configured to set a position of the viewpoint closer to the direction of change as the change amount increases.
